(19) United States
(12) Patent Application Publication
(10) Pub. No.: US 2013/0000848 A1
(43) Pub. Date: Jan. 3, 2013

(54) PEDESTAL WITH EDGE GAS DEFLECTOR FOR EDGE PROFILE CONTROL

(75) Inventors: Panya Wongsenakhum, San Francisco, CA (US); Gary Lind, Nevada City, CA (US); Prashanth Kothnur, Sunnyvale, CA (US)

(73) Assignee: Novellus Systems Inc., San Jose, CA (US)

(21) Appl. No.: 13/462,096

(22) Filed: May 2, 2012

Related U.S. Application Data
(60) Provisional application No. 61/503,959, filed on Jul. 1, 2011.

(51) Int. Cl. B05B 1/18; B05C 11/00

(52) U.S. Cl. 156/345.34; 156/345.51

(57) ABSTRACT

A substrate processing system includes a pedestal including a substrate supporting surface having a diameter that is greater than a diameter of a substrate to be processed by the substrate processing system. A first surface extends a first distance above the substrate supporting surface in a direction substantially perpendicular to the substrate supporting surface. The first distance is greater than or equal to one-half of a thickness of the substrate. A gap is defined between the first surface and an outer diameter of the substrate. A second surface extends a second distance from the first surface at an angle with respect to the first surface. The angle is greater than zero and less than ninety degrees. A third surface extends from the second surface and is substantially parallel to the substrate supporting surface. An etchant source directs etchant onto the substrate to etch the substrate.

### CROSS-REFERENCE TO RELATED APPLICATIONS

The present disclosure claims the benefit of U.S. Provisional Application No. 61/503,959, filed on Jul. 1, 2011, which is hereby incorporated by reference in its entirety.

### FIELD

The present disclosure relates to pedestals for substrate processing systems and methods.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A substrate such as a semiconductor wafer is typically positioned on a pedestal in a substrate processing chamber during deposition and etching of layers of the substrate. Referring now to FIGS. 1 and 2, a substrate processing system 100 includes a processing chamber 110 with a showerhead 114. A pedestal 120 is arranged below the showerhead 114. A substrate 126 is arranged on the pedestal 120. A heating element 130 with a power connection 132 may be used to control a temperature of the substrate 126. An RF bias circuit 140 may also be used to supply an RF bias to the substrate 126 and/or the showerhead 114.

The pedestal 120 typically defines a cavity 142 having a depth approximately equal to a thickness of the substrate 126. The cavity 142 is generally larger than the substrate 126 to accommodate the size of the substrate 126. Once the substrate 126 is positioned in the cavity 142, a surface of the substrate 126 and the area surrounding the cavity 142 are at about the same height.

An etchant such as atomic and molecular fluorine may be generated by introducing NF₃ in a remote plasma source above the substrate 126. The plasma may flow through the showerhead 114 that is arranged generally parallel to the substrate 126. The etchant is evacuated (typically by a vacuum pump) at the periphery of the pedestal at 136. As a result, etchant flows radially outwards after coming into contact with the substrate 126. This design creates a high etch rate near the edge of the substrate 126 and can cause high etch non-uniformity.

### SUMMARY

This section provides a general summary of the disclosure, and is not a comprehensive disclosure of its full scope or all of its features.

A substrate processing system includes a pedestal including a substrate supporting surface having a diameter that is greater than a diameter of a substrate to be processed by the substrate processing system. A first surface extends a first distance above the substrate supporting surface in a direction substantially perpendicular to the substrate supporting surface. The first distance is greater than or equal to one-half of a thickness of the substrate. A gap is defined between the first surface and an outer diameter of the substrate. A second surface extends a second distance from the first surface at an angle with respect to the first surface. The angle is greater than zero and less than ninety degrees. A third surface extends from the second surface and is substantially parallel to the substrate supporting surface. An etchant source directs etchant onto the substrate to etch the substrate.

In other features, the first distance is greater than or equal to three-quarters of the thickness of the substrate. The first distance is greater than or equal to the thickness of the substrate. The substrate supporting surface, the first surface, the second surface and the third surface are planar surfaces.

A chemical vapor deposition system includes a processing chamber. The substrate processing system is arranged in the processing chamber. The etchant source includes a showerhead arranged adjacent to the pedestal. Etchant flows through the showerhead onto the substrate.

A substrate processing system includes a pedestal including a substrate supporting surface having a diameter that is greater than a diameter of a substrate to be processed by the substrate processing system. A first surface extends a first distance below the substrate supporting surface in a direction substantially perpendicular to the substrate supporting surface. The first distance is greater than or equal to one-half of a thickness of the substrate. A gap is defined between the first surface and an outer diameter of the substrate. A second surface extends a second distance from the first surface at an angle with respect to the first surface. The angle is greater than zero and less than ninety degrees. A third surface extends from the second surface and is substantially parallel to the substrate supporting surface. An etchant source directs etchant onto the substrate to etch the substrate.

In other features, the first distance is greater than or equal to three-quarters of the thickness of the substrate. The first distance is greater than or equal to the thickness of the substrate. The substrate supporting surface, the first surface, the second surface and the third surface are planar surfaces.

A chemical vapor deposition system includes a processing chamber. The substrate processing system is arranged in the processing chamber. The etchant source includes a showerhead arranged adjacent to the pedestal. Etchant flows through the showerhead onto the substrate.

A substrate processing system includes a pedestal including a substrate supporting surface. A first surface extends from the substrate supporting surface at a first angle to a first distance below the substrate supporting surface. A second surface extends from the first surface. The second surface is parallel to the substrate supporting surface. A third surface extends from the second surface to a first location that is located greater than or equal to one-half of a thickness of the substrate above a plane including the substrate supporting surface. A fourth surface extends from the third surface and is substantially parallel to the substrate supporting surface and the second surface. An etchant source directs etchant onto the substrate to etch the substrate.

In other features, the first location is located greater than or equal to three-quarters of the thickness of the substrate above the plane including the substrate supporting surface. The first location is located greater than or equal to the thickness of the substrate above the plane including the substrate supporting surface. A fifth surface extends in a direction towards a plane including the substrate supporting surface. The substrate supporting surface, the first surface, the second surface, the third surface and the fourth surface are planar surfaces. The substrate supporting surface has a diameter that is greater than a diameter of a substrate to be processed on the substrate supporting surface. The substrate supporting surface has a diameter that is less than a diameter of a substrate to be processed on the substrate supporting surface.

A chemical vapor deposition system includes a processing chamber. The substrate processing system is arranged in the processing chamber. The etchant source includes a showerhead arranged adjacent to the pedestal. Etchant flows through the showerhead onto the substrate.

A substrate processing system includes a pedestal including a substrate supporting surface having a diameter that is greater than a diameter of a substrate to be processed by the substrate processing system. A first surface extends a first distance above the substrate supporting surface at a first angle relative to the substrate supporting surface. A gap is defined between the first surface and an outer diameter of the substrate. A second surface extends a second distance from the first surface at a second angle with respect to the substrate supporting surface. A third surface extends from the second surface and that is substantially parallel to the substrate supporting surface. The first angle and the second angle are greater than zero and less than ninety degrees. An etchant source directs etchant onto the substrate to etch the substrate.

In other features, the first distance is greater than or equal to one-half of the thickness of the substrate. The first distance is greater than or equal to three-quarters of the thickness of the substrate. The first distance is greater than or equal to the thickness of the substrate. The substrate supporting surface, the first surface, the second surface and the third surface are planar surfaces. The first angle is greater than 45 degrees and less than 90 degrees and the second angle is greater than 0 degrees and less than 45 degrees. The second angle is greater than 45 degrees and less than 90 degrees and the first angle is greater than 0 degrees and less than 45 degrees.

A chemical vapor deposition system includes a processing chamber. The substrate processing system is arranged in the processing chamber. The etchant source includes a showerhead arranged adjacent to the pedestal. Etchant flows through the showerhead onto the substrate.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a functional block diagram of a substrate processing chamber including a showerhead and a pedestal according to the prior art;

FIG. 2 shows results of modeling of the mass fraction of the atomic fluorine near the edge of the substrate for the pedestal of FIG. 1;

FIG. 3 is a functional block diagram of a substrate processing chamber including a showerhead and an example of a pedestal according to the present disclosure;

FIGS. 4-6 show results of modeling of the mass fraction of the atomic fluorine near the edge of the substrate for various other pedestals according to the present disclosure;

FIG. 7 shows results of modeling of the mass fraction of the atomic fluorine near the edge of the substrate for a flat pedestal;

FIG. 8 is a graph comparing mass fractions of atomic fluorine for various pedestals; and

FIGS. 9 and 10A-10E show additional examples of pedestals according to the present disclosure.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

The present disclosure describes a pedestal with an edge gas deflector portion. The pedestal is used to improve etch back uniformity in a substrate processing chamber when performing an etch back step on a substrate. The pedestal defines a cavity with a central portion to receive the substrate and an edge gas deflector portion with a pocket area or gap and a raised or lowered edge. The pocket area or gap is defined between an outer edge of the substrate and the raised edge of the cavity.

By adjusting the size of the gap, the height of the raised edge, and the shape of the raised edge (such as an angle of the raised edge), the etch rate at the edge of the substrate can be controlled. This improves etch uniformity or a desired edge profile. The etch rate at the edge of the substrate can be further adjusted if desired by introducing an edge purge gas to adjust the concentration of the etch species. While specific processes are described herein, the present disclosure may be used for other processes and reactive gases, and/or on other substrate processing tools.

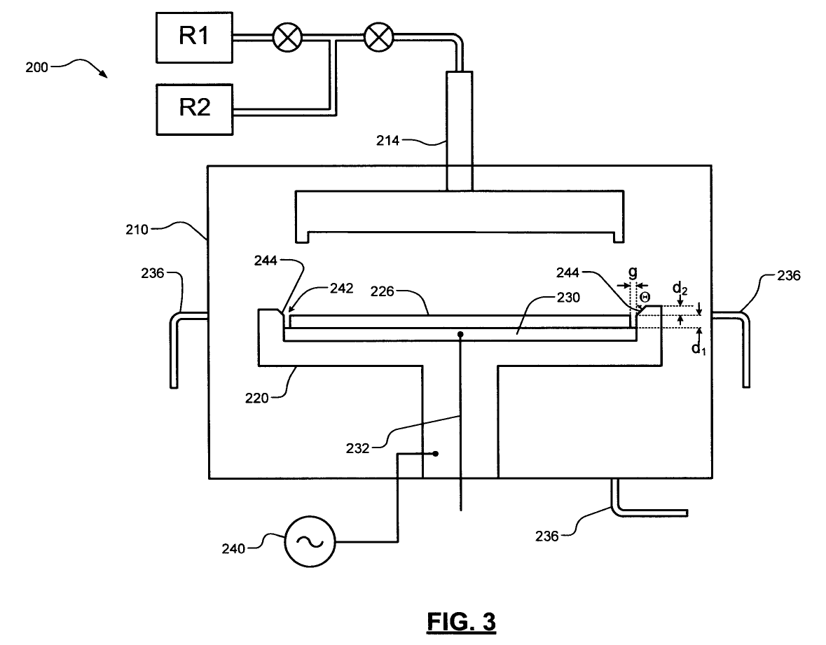

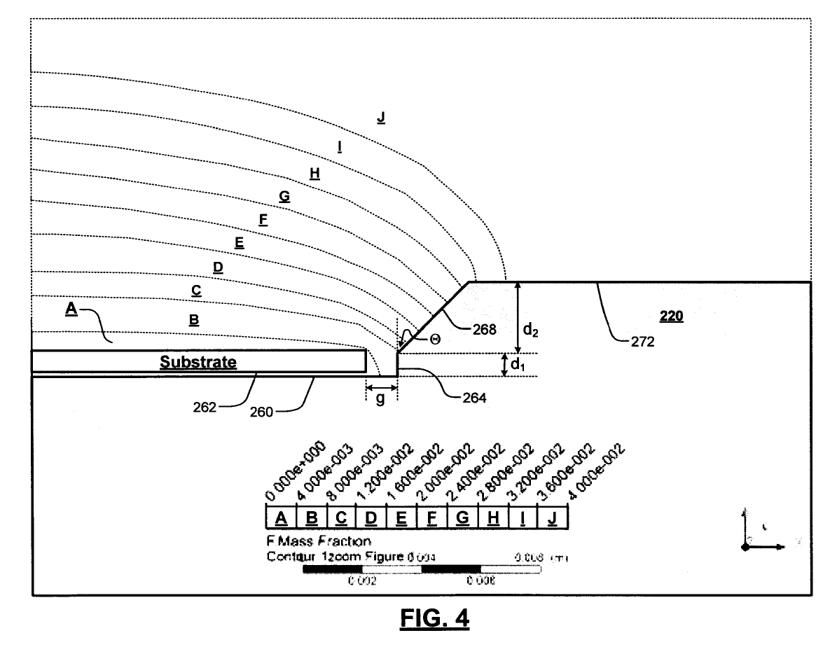

Referring now to FIGS. 3 and 4, a pedestal according to the present disclosure is shown. In FIG. 3, a substrate processing system 200 includes a processing chamber 210 with a showerhead 214. A pedestal 220 defines a cavity 242 and an edge gas deflector portion 244. The pedestal 220 is arranged below the showerhead 214. A substrate 226 is arranged on the pedestal 220 in a center portion of the cavity 242.

The pedestal 220 may include a heating element 230 supplied by a power connector 232, which may be used to control a temperature of the substrate 226. An RF bias circuit 240 may be used to supply an RF bias to the pedestal 220 and the substrate 226. The cavity 242 is generally larger than the substrate 226 to accommodate the size of the substrate 226.

In some examples, the edge gas deflector portion 244 defines a gap g, a distance d1 and a distance d2. The gap g is defined between an outer edge of the substrate 226 and a first surface of the raised edge of the edge gas deflector portion 244. The first surface of the raised edge extends the distance d1 from the pedestal surface and may extend generally vertical relative to an upper horizontal surface of the pedestal (or generally parallel to an edge of the substrate). A second surface of the raised edge extends a distance d2 at an angle Θ. The angle Θ may be greater than 0° and less than 90°, although other angles may be used. While the first and second surfaces are generally planar, one or more curved sections can be used.

An etchant such as atomic and molecular fluorine may be generated by introducing NF₃ in a remote plasma source above the substrate 226 or using any other suitable method. The plasma may flow through the showerhead 214 that is arranged generally parallel to the substrate 226. The etchant is evacuated at the periphery of the pedestal at 236. As a result, etchant flows radially outwards after coming into contact with the substrate 226.

As can be seen in FIG. 4, the pedestal 220 with the edge gas deflector portion 244 reduces etch non-uniformity by deflecting the gas flow near the substrate edge area. By doing so, the boundary layer/flow line of the gas that flows along the substrate edge changes and causes changes in the mass fraction of the atomic fluorine near the edge of the substrate.

More particularly in the example in FIG. 4, the pedestal 220 includes a substrate supporting surface 260 having a diameter that is greater than a diameter of a substrate 262. A first surface 264 extends a first distance d₁ above the substrate supporting surface 260 in a direction substantially perpendicular to the substrate supporting surface 260. The first surface 264 defines a gap g between the first surface 264 and an outer diameter of the substrate 262. In some examples, the first distance d₁ is greater than or equal to one-half of a thickness of the substrate 262.

A second surface 268 extends a second distance d₂ from the first surface 264 at an angle Θ with respect to the first surface 264. In some examples, the angle Θ is greater than zero and less than ninety degrees. A third surface 272 extends from the second surface 268 and is substantially parallel to the substrate supporting surface 260.

In some examples, the first distance d₁ is greater than or equal to three-quarters of the thickness of the substrate 262. In other examples, the first distance d₁ is greater than or equal to the thickness of the substrate 262. In still other examples, the first distance d₁ is greater than the thickness of the substrate. In some examples, the first surface, the second surface and the third surface are planar surfaces. Alternately, one or more of the first surface, the second surface and the third surface can be non-planar surfaces.

In some examples, the gap g is 0.5 mm to 4 mm, although other values may be used. In other examples, the gap g is 1 mm to 3 mm, although other values may be used. In some examples, the distance d1 is 0.5 mm to 8 mm, although other values may be used. In other examples, the distance d1 is 1 mm to 3 mm, although other values may be used. In some examples, the distance d2 is 0.5 mm to 6 mm, although other values may be used. In other examples, the distance d2 is 1 mm to 4 mm, although other values may be used. In some examples, Θ is between 30 and 60 degrees, although other values may be used.

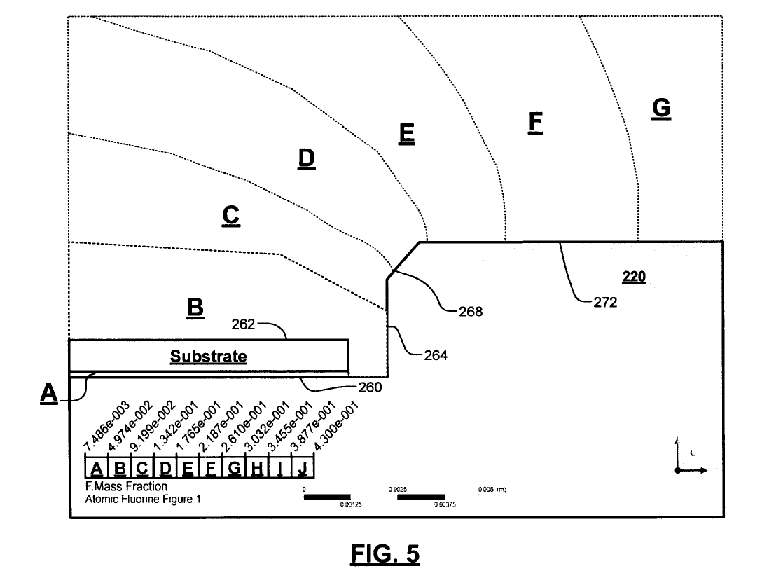

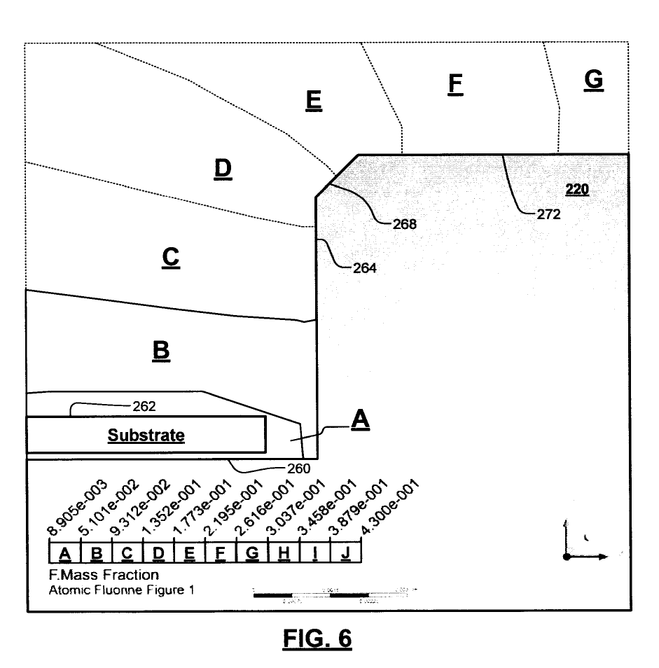

Referring now to FIGS. 5 and 6, other examples of pedestals with pocket areas having different values of g, h1, h2, and/or Θ are shown. As can be appreciated, variations in the etch profile can be achieved by varying g, h1, h2, and/or Θ.

The edge gas deflector portion may be removable from the pedestals. For example only, an edge gas deflector portion 273 in FIG. 5 is removable. An edge 275 of the edge gas deflector portion 273 lies along a surface of the pedestal 220. One or more fasteners 277 may be used to removably attach the edge gas deflector portion 273 to the pedestal 220. In some examples, the fasteners 277 may include one or more sets of alignment pins.

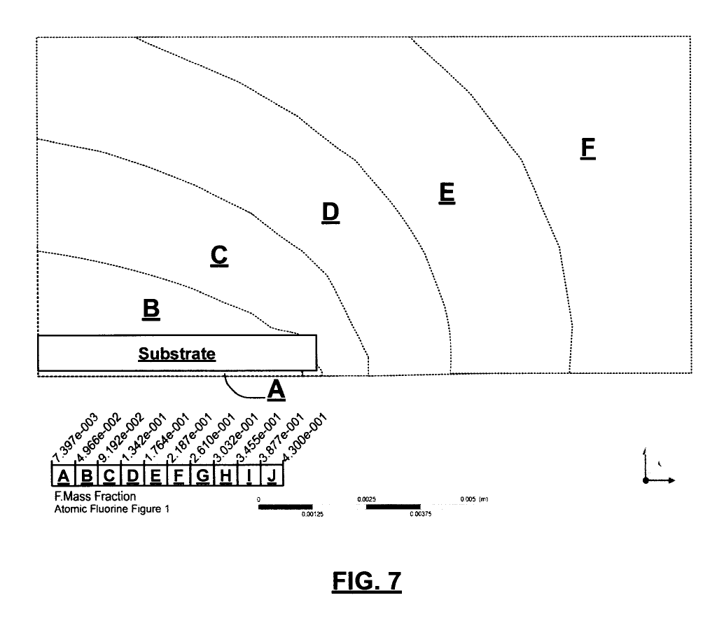

Referring now to FIG. 7, the mass fraction of fluorine is shown for a planar pedestal for comparison purposes.

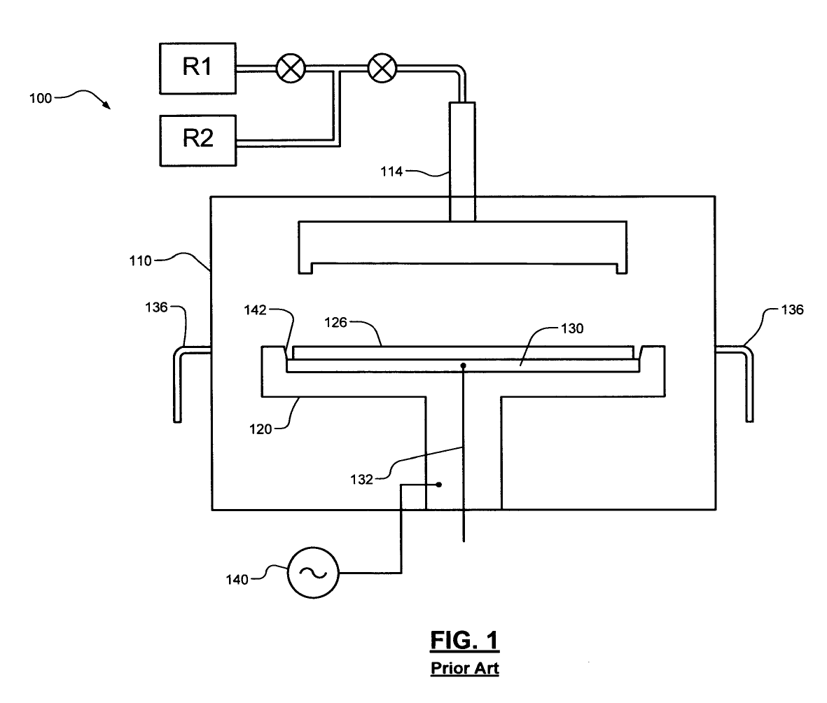

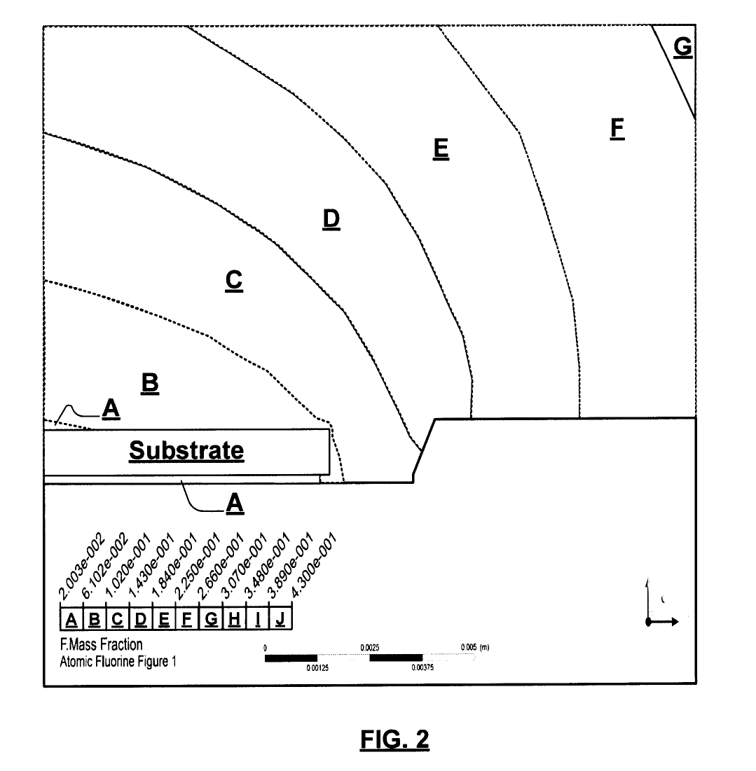

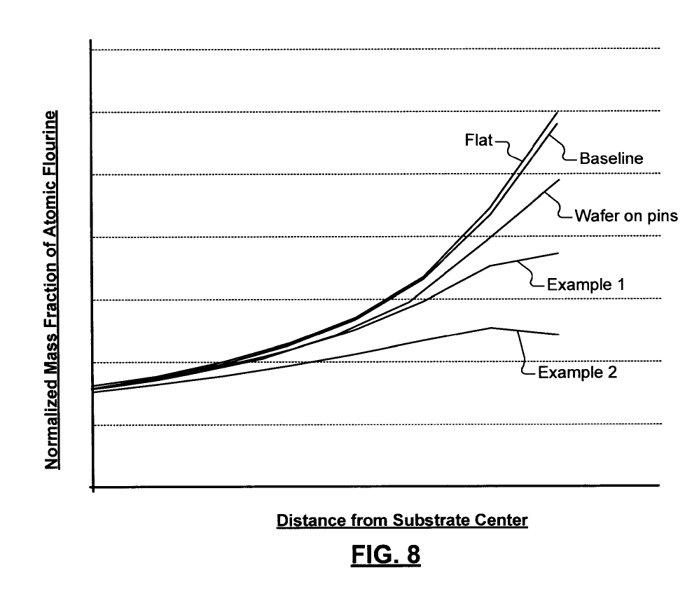

Referring now to FIG. 8, a graph shows the mass fraction of atomic fluorine (normalized) as a function of radial distance from a center of the substrate for various pedestals. The pedestals having the edge gas deflector portion 244 with the gap and raised edge as described above in conjunction with FIGS. 3-6 (see Examples 1 and 2) show more uniform concentrations of the etch species as the radial distance increases as compared to flat (FIG. 7) or conventional (FIG. 1) approaches. As a result, etch uniformity for substrates etched with these pedestals will be more uniform.

Additionally, edge purge gas can be introduced near the edge of the substrate to couple with deflection geometry described above to further reduce the concentration of the etch species.

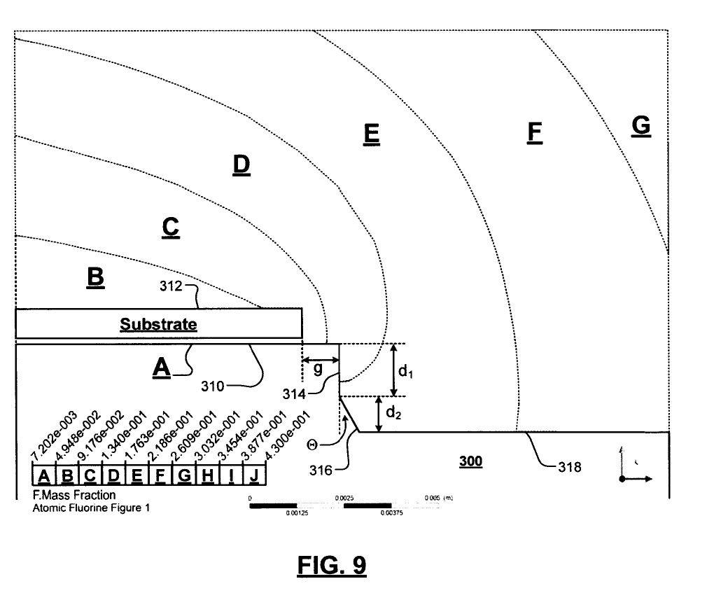

In FIG. 9, an edge of a pedestal 300 is inverted relative to those shown in FIGS. 4-6. The pedestal 300 includes a substrate supporting surface 310 having a diameter that is greater than a diameter of a substrate 312. A first surface 314 extends a first distance d₁ below the substrate supporting surface 310 in a direction substantially perpendicular to the substrate supporting surface 310. A gap g is defined between the radially outer edge of the substrate supporting surface 310 and an outer diameter of the substrate 312. In some examples, the first distance d₁ is greater than or equal to one-half of a thickness of the substrate 312. A second surface 316 extends a second distance d₂ from the first surface at an angle Θ with respect to the first surface 314. For example only, the angle Θ is greater than zero and less than ninety degrees. A third surface 318 extends from the second surface and is substantially parallel to the substrate supporting surface.

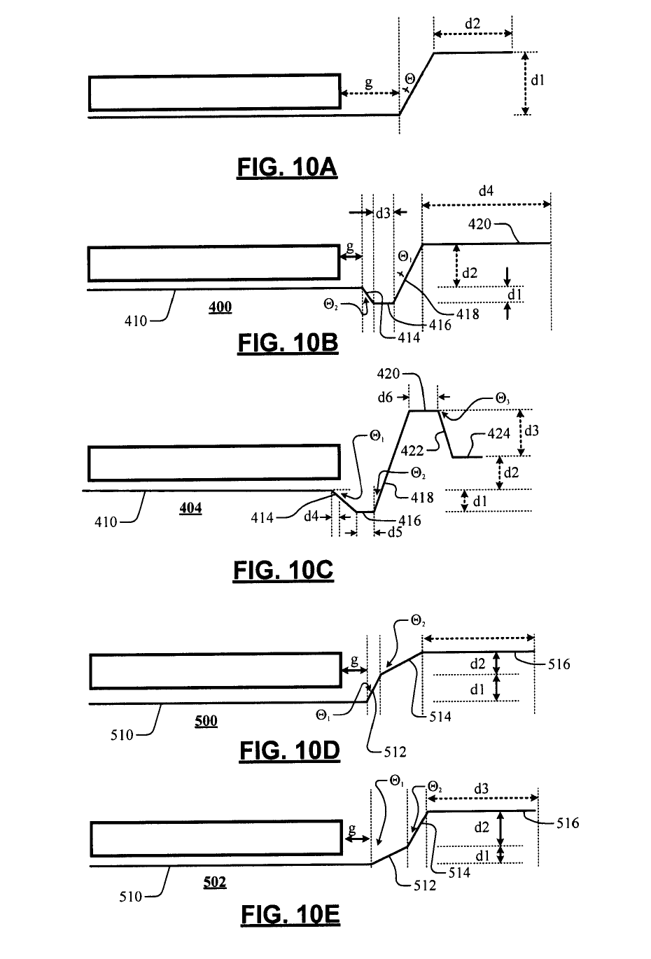

Referring now to FIGS. 10A-10E, additional examples of pedestals according to the present disclosure are shown.

In FIG. 10A, distance d1 can be greater than, less than or equal to a height of the substrate. The angle Θ can be greater than 0° and less than 90°.

In FIG. 10B, the substrate supporting surface has a diameter that is greater than a diameter of a substrate. A pedestal 400 may have a portion that dips (a distance d1) below a surface of the pedestal supporting the substrate. The distance d2 may be greater than, less than or equal to a height of the substrate. The angle Θ can be greater than 0° and less than 90°.

More particularly, the pedestal 400 includes a substrate supporting surface 410. A first surface 414 extends from the substrate supporting surface 410 to a first distance below the substrate supporting surface 410. A second surface 416 extends from the first surface 414. In some examples, the second surface 416 is parallel to the substrate supporting surface 410. A third surface 418 extends from the second surface 416 to a first distance that is greater than or equal to one-half of a thickness of the substrate above the substrate supporting surface 410. A fourth surface 420 extends from the third surface 418 and is substantially parallel to the substrate supporting surface 410 and the second surface 416.

In FIG. 10C, the substrate supporting surface has a diameter that is less than a diameter of a substrate. A pedestal 404 may have a portion that initially dips a distance d1 below a surface of the pedestal supporting the substrate. The dipped portion may start a distance d4 radially inside of a radially outer edge of the substrate. The distance d2+d3 may be greater than, less than or equal to a height of the substrate. The distance d3 may be greater than, less than or equal to the distance d2+d3. The angles Θ₁-Θ₃ can be greater than 0° and less than 90°.

Additionally, the pedestal 404 includes a fifth surface 422 that extends from the fourth surface 420 in a direction towards a plane including the substrate supporting surface 410. A sixth surface 424 extends from the fifth surface in a plane parallel to the substrate supporting surface 410.

In FIG. 10D, the angle Θ₂ can be greater than the angle Θ₁. Both Θ₁ and Θ₂ may be greater than 0° and less than 90°. In FIG. 10E, the angle Θ₁ can be greater than the angle Θ₂. Both Θ₁ and Θ₂ may be greater than 0° and less than 90°.

In FIGS. 10D and 10E, the pedestals 500 and 502, respectively, include a substrate supporting surface 510. A first surface 512 extends a first distance d1 above the substrate supporting surface 510 at a first angle Θ₁ relative to the substrate supporting surface 510. A second surface 514 extends a second distance d2 from the first surface 512 at a second angle Θ₂ with respect to the substrate supporting surface 510. A third surface 516 extends from the second surface 514 and is substantially parallel to the substrate supporting surface 510. In FIG. 10D, the first angle Θ₁ is greater than 45 degrees and less than 90 degrees and the second angle Θ₂ is greater than 0 degrees and less than 45 degrees. In FIG. 10E, the second angle Θ₂ is greater than 45 degrees and less than 90 degrees and the first angle Θ₁ is greater than 0 degrees and less than 45 degrees.

As can be appreciated, one or more curved segments can be used to replace one or more of the line segments shown in FIGS. 10A-10E.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A substrate processing system, comprising:
a pedestal including:
a substrate supporting surface having a diameter that is greater than a diameter of a substrate to be processed by the substrate processing system;
a first surface that extends a first distance above the substrate supporting surface in a direction substantially perpendicular to the substrate supporting surface,
wherein the first distance is greater than or equal to one-half of a thickness of the substrate, and wherein a gap is defined between the first surface and an outer diameter of the substrate;
a second surface that extends a second distance from the first surface at an angle with respect to the first surface, wherein the angle is greater than zero and less than ninety degrees; and
a third surface that extends from the second surface and that is substantially parallel to the substrate supporting surface; and
an etchant source that directs etchant onto the substrate to etch the substrate.

2. The substrate processing system of claim 1, wherein the first distance is greater than or equal to three-quarters of the thickness of the substrate.

3. The substrate processing system of claim 1, wherein the first distance is greater than or equal to the thickness of the substrate.

4. The substrate processing system of claim 1, wherein the substrate supporting surface, the first surface, the second surface and the third surface are planar surfaces.

5. A chemical vapor deposition system, comprising:
a processing chamber; and
the substrate processing system of claim 1 arranged in the processing chamber, wherein the etchant source includes a showerhead arranged adjacent to the pedestal.

6. The chemical vapor deposition system 5, wherein etchant flows through the showerhead onto the substrate.

7. A substrate processing system, comprising:
a pedestal including:
a substrate supporting surface having a diameter that is greater than a diameter of a substrate to be processed by the substrate processing system;
a first surface that extends a first distance below the substrate supporting surface in a direction substantially perpendicular to the substrate supporting surface,
wherein the first distance is greater than or equal to one-half of a thickness of the substrate, and wherein a gap is defined between the first surface and an outer diameter of the substrate;
a second surface that extends a second distance from the first surface at an angle with respect to the first surface, wherein the angle is greater than zero and less than ninety degrees; and
a third surface that extends from the second surface and that is substantially parallel to the substrate supporting surface; and
an etchant source that directs etchant onto the substrate to etch the substrate.

8. The substrate processing system of claim 7, wherein the first distance is greater than or equal to three-quarters of the thickness of the substrate.

9. The substrate processing system of claim 7, wherein the first distance is greater than or equal to the thickness of the substrate.

10. The substrate processing system of claim 7, wherein the substrate supporting surface, the first surface, the second surface and the third surface are planar surfaces.

11. A chemical vapor deposition system, comprising:
a processing chamber; and
the substrate processing system of claim 7 arranged in the processing chamber,
wherein the etchant source includes a showerhead arranged adjacent to the pedestal.

12. The chemical vapor deposition system 11, wherein etchant flows through the showerhead onto the substrate.

13. A substrate processing system, comprising:
a pedestal including:
a substrate supporting surface;
a first surface that extends from the substrate supporting surface at a first angle to a first distance below the substrate supporting surface;
a second surface that extends from the first surface, wherein the second surface is parallel to the substrate supporting surface;
a third surface that extends from the second surface to a first location that is located greater than or equal to one-half of a thickness of the substrate above a plane including the substrate supporting surface; and
a fourth surface that extends from the third surface and that is substantially parallel to the substrate supporting surface and the second surface;
an etchant source that directs etchant onto the substrate to etch the substrate.

14. The substrate processing system of claim 13, wherein the first location is located greater than or equal to three-quarters of the thickness of the substrate above the plane including the substrate supporting surface.

15. The substrate processing system of claim 13, wherein the first location is located greater than or equal to the thickness of the substrate above the plane including the substrate supporting surface.

16. The substrate processing system of claim 13, further comprising a fifth surface that extends in a direction towards a plane including the substrate supporting surface.

17. The substrate processing system of claim 13, wherein the substrate supporting surface, the first surface, the second surface, the third surface and the fourth surface are planar surfaces.

18. The substrate processing system of claim 13, wherein the substrate supporting surface has a diameter that is greater than a diameter of a substrate to be processed on the substrate supporting surface.

19. The substrate processing system of claim 13, wherein the substrate supporting surface has a diameter that is less than a diameter of a substrate to be processed on the substrate supporting surface.

20. A chemical vapor deposition system, comprising:
a processing chamber; and
the substrate processing system of claim 13 arranged in the processing chamber,
wherein the etchant source includes a showerhead arranged adjacent to the pedestal.

21. The chemical vapor deposition system 20, wherein etchant flows through the showerhead onto the substrate.

22. A substrate processing system, comprising:
a pedestal including:
a substrate supporting surface having a diameter that is greater than a diameter of a substrate to be processed by the substrate processing system;
a first surface that extends a first distance above the substrate supporting surface at a first angle relative to the substrate supporting surface, wherein a gap is defined between the first surface and an outer diameter of the substrate;
a second surface that extends a second distance from the first surface at a second angle with respect to the substrate supporting surface; and
a third surface that extends from the second surface and that is substantially parallel to the substrate supporting surface, wherein the first angle and the second angle are greater than zero and less than ninety degrees; and
an etchant source that directs etchant onto the substrate to etch the substrate.

23. The substrate processing system of claim 22, wherein the first distance is greater than or equal to one-half of the thickness of the substrate.

24. The substrate processing system of claim 22, wherein the first distance is greater than or equal to three-quarters of the thickness of the substrate.

25. The substrate processing system of claim 22, wherein the first distance is greater than or equal to the thickness of the substrate.

26. The substrate processing system of claim 22, wherein the substrate supporting surface, the first surface, the second surface and the third surface are planar surfaces.

27. The substrate processing system of claim 22, wherein the first angle is greater than 45 degrees and less than 90 degrees and wherein the second angle is greater than 0 degrees and less than 45 degrees.

28. The substrate processing system of claim 22, wherein the second angle is greater than 45 degrees and less than 90 degrees and wherein the first angle is greater than 0 degrees and less than 45 degrees.

29. A chemical vapor deposition system, comprising:
a processing chamber; and
the substrate processing system of claim 22 arranged in the processing chamber,
wherein the etchant source includes a showerhead arranged adjacent to the pedestal.

30. The chemical vapor deposition system 29, wherein etchant flows through the showerhead onto the substrate.
